(19) United States
(12) Patent Application Publication
(10) Pub. No.: US 2026/0260523 A1
(43) Pub. Date: Sep. 3, 2026

(54) VEHICLE DIAGNOSTICS USING NEAR-FIELD COMMUNICATION (NFC)

(71) Applicant: Innova Electronics Corporation, Irvine, CA (US)

(72) Inventors: Ly BACH, Ho Chi Minh City (VN); Phuong PHAM, Fountain Valley, CA (US); Kha VO, Nui Thanh/Quang Nam (VN); Benjamin PHAM, Fountain Valley, CA (US); Kevin WONG, West Hills, CA (US)

(21) Appl. No.: 19/067,289

(22) Filed: Feb. 28, 2025

(51) Int. Cl. G07C 5/00; G07C 5/08; H04W 76/14

(52) U.S. Cl. CPC G07C 5/008; G07C 5/006; G07C 5/0841; H04W 76/14

(57) ABSTRACT

A method of supporting vehicle diagnostics includes establishing a first wireless connection with a diagnostic tool connected to a diagnostic port of a vehicle, receiving identification information of the vehicle over the first wireless connection, determining a user profile based on the identification information of the vehicle, exchanging pairing information over the first wireless connection, establishing a second wireless connection with the diagnostic tool based on the pairing information, receiving diagnostic data of the vehicle over the second wireless connection, and producing a vehicle health report based on the user profile and the received diagnostic data. The first wireless connection may comprise a near-field communication (NFC) connection, and the second wireless connection may have a longer range than the first wireless connection.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

Automotive scan tools have the potential to empower vehicle owners to take matters into their own hands when it comes to vehicle diagnostics. Using a scan tool, a vehicle owner can retrieve diagnostic data from the vehicle's various systems and access a diagnostic database to derive a diagnostic condition of the vehicle including, for example, a most likely root cause of a problem that the vehicle owner is experiencing. In this way, the vehicle owner can streamline the process of servicing the vehicle and/or finding the necessary parts to repair the vehicle. By using a scan tool in conjunction with a smartphone, tablet, or other mobile device, the vehicle owner may further take advantage of any number of mobile applications (“apps”) that offer additional benefits, such as expanded diagnostic functionality including early warning detection and scheduled maintenance reminders, a superior display and touchscreen interface for enhanced data visualization and usability, and/or secure access to a user profile to allow for personalization and customization based on existing mobile device user authentication techniques (e.g., face recognition, two-factor, API login, etc.).

Unfortunately, despite the relative ease with which such automotive diagnostic apps may be downloaded and updated by the vehicle owner (e.g., using the Apple App Store or Google Play Store), the added complexity of interfacing the mobile device with the scan tool creates a barrier for adoption of such apps by users who value simplicity and convenience, most notably the vehicle owners themselves (as opposed to service technicians, for example). As a result, vehicle owners typically do not connect their mobile devices to scan tools, either enjoying only limited functionality of the app in question or else forgoing use of the app altogether.

In addition to their inconvenience, conventional methods of interfacing a mobile device with a scan tool (e.g., by Bluetooth) do not allow for automatic whitelisting, blacklisting, or prioritizing the connection on the basis of the vehicle's identity or characteristics. For example, if a user of the mobile devices is within range to wirelessly connect to two or more different scan tools attached to different vehicles (e.g., in a service center garage), the user must manually select or prioritize the intended device based on its device name (or ID) appearing in a list among others. By default, these device names may be ambiguous and unhelpful, such as a device name that is only the name of the manufacturer, one that is a generic phrase such as “scan tool,” or one that is a seemingly arbitrary alphanumeric code.

### BRIEF SUMMARY

The present disclosure contemplates various systems and methods for overcoming the above drawbacks accompanying the related art. A vehicle owner, technician, or other user of the disclosed subject matter may simply tap his/her mobile device to a scan tool connected to a vehicle's OBD-II port. In response to the tap or close proximity of the mobile device to the scan tool, the mobile device may exchange pairing information with the scan tool over a Near Field Communication (NFC) connection to establish a Bluetooth connection therebetween. The Bluetooth connection may then be used by a mobile application (“app”) installed on the mobile device to receive diagnostic trouble codes (DTCs) and other diagnostic data collected by the scan tool, to exchange control signals with the scan tool, and/or to update firmware or a diagnostic database on the scan tool. The initial NFC connection may additionally be used to send a portion of the diagnostic data from the scan tool to the mobile device, most advantageously a portion including a vehicle identification number (VIN) associated with the vehicle. By allowing the mobile device to have access to the VIN up front, the NFC connection makes it possible for the mobile device to selectively establish the Bluetooth connection or not, based on the identity of the vehicle or the type of vehicle (as may be determined from the VIN). In addition, the VIN may be used by the app to look up a user profile (or a vehicle profile) associated with the vehicle. The information in the profile may be used to automatically change default settings in the app in order to preselect certain diagnostic functionality or otherwise streamline the user's experience with the app.

One aspect of the embodiments of the present disclosure is a computer program product comprising one or more non-transitory program storage media on which are stored instructions executable by one or more processors or programmable circuits to perform operations for supporting vehicle diagnostics. The operations may comprise establishing a first wireless connection with a diagnostic tool connected to a diagnostic port of a vehicle. The first wireless connection may comprise a near-field communication (NFC) connection. The operations may further comprise receiving identification information of the vehicle over the first wireless connection, determining a user profile based on the identification information of the vehicle, exchanging pairing information over the first wireless connection, and establishing a second wireless connection with the diagnostic tool based on the pairing information. The second wireless connection may have a longer range than the first wireless connection and may comprise, for example, a Bluetooth connection. The operations may further comprise receiving diagnostic data of the vehicle over the second wireless connection and producing a vehicle health report based on the user profile and the received diagnostic data.

Another aspect of the embodiments of the present disclosure is a method of supporting vehicle diagnostics. The method may comprise establishing a first wireless connection with a diagnostic tool connected to a diagnostic port of a vehicle. The first wireless connection may comprise a near-field communication (NFC) connection. The method may further comprise receiving identification information of the vehicle over the first wireless connection, determining a user profile based on the identification information of the vehicle, exchanging pairing information over the first wireless connection, and establishing a second wireless connection with the diagnostic tool based on the pairing information. The second wireless connection may have a longer range than the first wireless connection and may comprise, for example, a Bluetooth connection. The method may further comprise receiving diagnostic data of the vehicle over the second wireless connection and producing a vehicle health report based on the user profile and the received diagnostic data.

Another aspect of the embodiments of the present disclosure is a system for supporting vehicle diagnostics. The system may comprise a diagnostic tool configured to connect to a diagnostic port of a vehicle to retrieve diagnostic data from the vehicle. The system may further comprise a mobile communication device configured to establish a first wireless connection with the diagnostic tool, receive identification information of the vehicle over the first wireless connection, determine a user profile based on the identification information of the vehicle, exchange pairing information over the first wireless connection, establish a second wireless connection with the diagnostic tool based on the pairing information, receive diagnostic data of the vehicle over the second wireless connection, and produce a vehicle health report based on the user profile and the received diagnostic data. The first wireless connection may comprise a near-field communication (NFC) connection and the second wireless connection may have a longer range than the first wireless connection and may comprise, for example, a Bluetooth connection.

In any of the above aspects, the operations, steps, and/or mobile communication device functions may comprise sending a firmware update and/or a database update to the diagnostic tool over the first wireless connection. Receiving the diagnostic data of the vehicle over the second wireless connection may be in response to the NFC connection being out of range. The operations, steps, and/or mobile communication device functions may comprise receiving diagnostic data of the vehicle over the first wireless connection, and the diagnostic data received over the second wireless connection may be a remaining portion of diagnostic data retrieved from the vehicle by the diagnostic tool after the NFC connection goes out of range. The identification information may include a vehicle identification number (VIN) of the vehicle. The diagnostic data may include one or more diagnostic trouble codes (DTCs), live data, and/or freeze frame data. The vehicle health report may include an identification of a defect in the vehicle, an identification of a recommended service item for the vehicle, and/or an identification of a recommended replacement part for the vehicle. Determining the user profile may include communicating the identification information of the vehicle to one or more servers and receiving the user profile from the one or more servers. The one or more servers may be in communication with the mobile communication device and may be configured to receive the identification information of the vehicle from the mobile communication device and to provide the user profile to the mobile communication device based on the identification information of the vehicle. Establishing the second wireless connection with the diagnostic tool may be further based on the user profile. The vehicle health report may be produced in response to an NFC tap of one or more NFC stickers, which may be included in contemplated systems described herein.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for supporting vehicle diagnostics according to one or more embodiments of the present disclosure;

FIG. 2 shows the system at a subsequent moment in time;

FIG. 3 shows an example operational flow of the system; and

FIG. 4 shows another example operational flow of the system.

### DETAILED DESCRIPTION

The present disclosure encompasses various embodiments of systems and methods for supporting vehicle diagnostics using a near-field communication (NFC) connection or other communication protocol having a range on the order of centimeters or inches. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

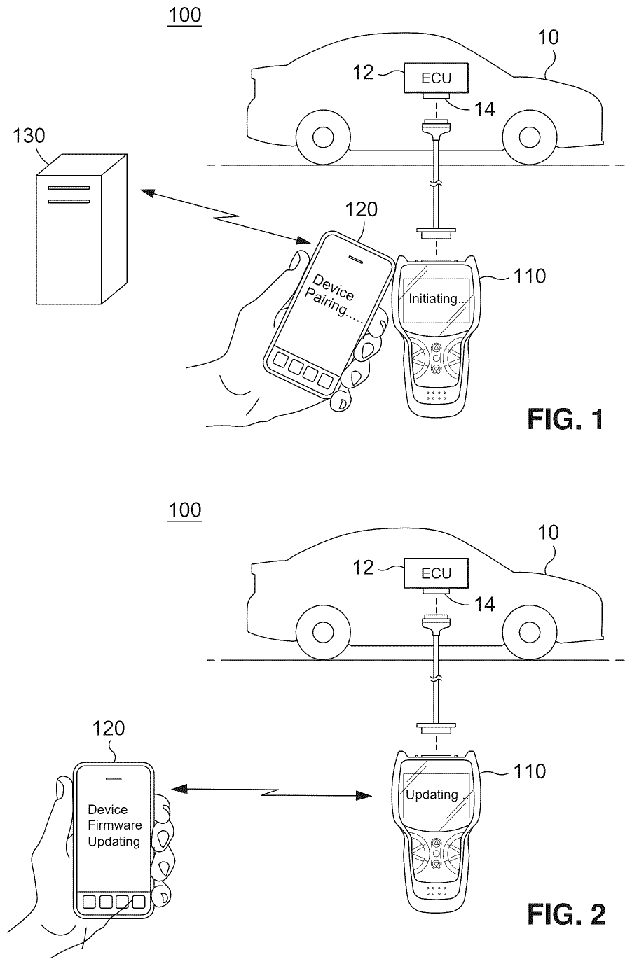

FIGS. 1 and 2 show a system 100 for supporting vehicle diagnostics according to one or more embodiments of the present disclosure. The system 100 may include a diagnostic tool 110 such as a scan tool or dongle that may be capable of connecting to a vehicle 10 to access a vehicle electronic control unit (ECU) 12 via a diagnostic port 14 (e.g., an OBD-II port). Unlike conventional scan tools, the diagnostic tool 110 may include a near-field communication (NFC) integrated circuit (IC) such as an NFC tag or NFC controller and antenna. An NFC-enabled mobile communication device 120 (also referred to as a mobile device), such as a smartphone or tablet, may establish an NFC connection with the diagnostic tool 110 to initiate a seamless transfer of data to the mobile communication device 120 and/or to enable control of the diagnostic tool 110 by a mobile application (“app”) installed on the mobile communication device 120. Through use of the NFC connection as described herein, the user is able to take advantage of the app's expanded diagnostic functionality and user-specific customization while benefiting from increased convenience and security, as well as reduced likelihood of user error.

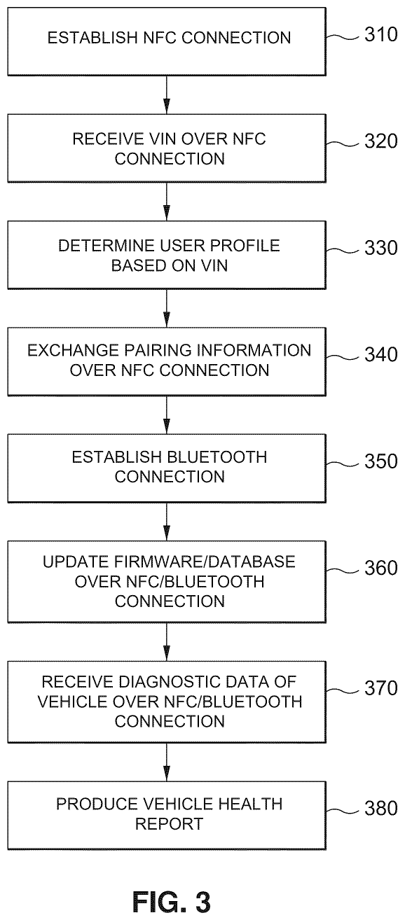

FIG. 3 shows an example operational flow 300 of the system 100, which may be performed by the mobile communication device 120. Referring to FIG. 3 together with FIGS. 1 and 2, the operational flow 300 may begin with establishing a first wireless connection with the diagnostic tool 110 that is connected to the diagnostic port 14 of the vehicle 10 (step 310). As contemplated herein, the first wireless connection may advantageously have a range on the order of centimeters or inches and may comprise an NFC connection, for example. Such a limited range may address security concerns, as it may effectively limit connections to those devices that are within the vehicle. The limited range may also beneficially avoid any ambiguity that might otherwise occur when multiple devices are in range, such as in a vehicle service center. FIG. 1 illustrates the user tapping the mobile communication device 120 to the diagnostic tool 110 to bring the two devices into close proximity with each other (more specifically, to bring an antenna of the mobile communication device 120 within proximity of an NFC tag or antenna of the diagnostic tool 110). In this way, the mobile communication device 120 may establish the first wireless connection (e.g., NFC). At this stage, the mobile communication device 120 may begin to receive data from the diagnostic tool 110 over the first wireless connection, beginning in particular with identification information of the vehicle 10 such as a vehicle identification number (VIN) (step 320).

By accessing the VIN at the outset, the mobile communication device 120 may advantageously preload a user profile. In particular, before continuing with the operational flow 300, the mobile communication device 120 may determine a user profile based on the VIN (step 330). This may be done locally on the mobile communication device 120, for example, by checking for a match between the VIN received from the vehicle 10 and a stored VIN associated with a user profile stored on the mobile communication device 120. A match may allow the operational flow 300 to continue, while a mismatch may return an error or communication failure (e.g., terminating the operational flow) due to the vehicle 10 being an unknown vehicle not associated with the user profile. This may be useful for implementations that allow a mobile communication device 120 to interface with exactly one vehicle 10, which may be pre-registered within the app, for example.

Alternatively, the determination of the user profile based on the VIN may be done through communication with one or more servers 130. As illustrated in FIG. 1, for example, the mobile communication device 120 may communicate the VIN to one or more servers 130 over a network such as the Internet using a wireless transceiver of the mobile communication device 120 (e.g., over cellular, Wi-Fi, or other wireless network(s)). The one or more servers 130 may be configured to receive the VIN or other identification information of the vehicle 10 from the mobile communication device 120 and provide a matching user profile back to the mobile communication device 120 (e.g., after querying a lookup table or database to find the matching user profile). This kind of system 100, where the mobile device 120 determines the user profile by communicating with one or more backend servers 130, may be useful for implementations in which the mobile communication device 120 is expected to interface with multiple different vehicles 10, such as in the context of a vehicle service center where a technician is using an app installed on a mobile communication device 120 to service vehicles 10 belonging to customers.

The operational flow 300 of FIG. 3 may continue with exchanging pairing information over the NFC or other first wireless connection (step 340) and establishing a second wireless connection with the diagnostic tool 110 based on the pairing information (step 350), as represented in FIG. 1 by the “Device Pairing...” text displayed on the mobile communication device 120. The second wireless connection may have longer range than the first wireless connection and may, for example, be a Bluetooth connection, allowing for the mobile communication device 120 to thereafter be separated from the diagnostic tool 110 by a greater distance (outside the range of the first wireless connection) as shown in FIG. 2. By exchanging the pairing information (e.g., cryptographic keys, etc.) over the first wireless connection, it is unnecessary for a user to manually select the diagnostic tool 110 in settings on the mobile communication device 120 as would otherwise be necessary for an initial pairing. Authorization to connect over the second wireless connection may be presumed based on the proximity of the mobile communication device 120 to the diagnostic tool 110, as the short range of the first wireless connection may effectively require a user to tap the mobile communication device 120 to the diagnostic tool 110 (strongly implying the user's intention to initiate pairing and data transfer).

The second wireless connection may be established further based on the user profile associated with the vehicle 10. In particular, by preloading a user profile associated with the VIN of the vehicle 10 as described above, the settings, preferences, authorizations, or other information stored in the user profile may be used to determine whether to pair as well as any parameters or settings related to pairing with the diagnostic tool 110. This may allow the pairing process not only to be automated (requiring no action on the part of the user other than tapping the diagnostic tool 110 with the mobile communication device 120) but also to be “smart” in the sense that user-specific pairing rules may be followed for the particular vehicle 10 or diagnostic tool 110 in question. For instance, the user profile may restrict or allow access to specific vehicles 10 or diagnostic tools 110 by keeping a blacklist or whitelist. When the mobile communication device 120 connects to the diagnostic tool 110 over the first wireless connection (e.g., NFC) and determines the user profile based on the VIN as described above, the blacklist or whitelist may be applied to determine whether it is permissible to exchange pairing information and establish the second wireless connection (e.g., Bluetooth). As another example, the user profile may store connection settings for the particular vehicle 10 or diagnostic tool 110, such as whether to remember the connection. In the case of a technician using the mobile communication device 120 to service vehicles 10 of many customers, for example, the user profile associated with the vehicle 10 may disallow the technician's mobile communication device 120 to remember the connection, thereby preventing later unauthorized connection of the mobile communication device 120 to the customer's vehicle 10 (e.g., from outside the vehicle 10). In effect, a new tap to exchange pairing information over the first wireless connection (possible only within the vehicle) may be required for each subsequent connection. This may be preferable from the perspective of a customer who may or may not bring the vehicle 10 to the same technician (using the same mobile communication device 120) in the future.

The operational flow of FIG. 3 may continue with updating firmware and/or a database stored on the diagnostic tool 110 (step 360) (e.g., the diagnostic tool 110 may maintain a local database used for decoding DTCs as they are retrieved from the vehicle 10), as well as transmission of the diagnostic data of the vehicle 10 from the diagnostic tool 110 to the mobile communication device 120 (step 370). The mobile communication device 120 may send the firmware and/or database update to the diagnostic tool 110 over the first wireless connection (e.g., NFC) and/or over the second wireless connection (e.g., Bluetooth), depending on the size of the files to be transmitted and the length of time that the first wireless connection is in range (e.g., how long the user holds the mobile communication device 120 in close proximity to the diagnostic tool 110). When the diagnostic tool 110 is no longer in close enough range of the mobile communication device 120 to maintain the first wireless connection (e.g., NFC), such as when the user has finished tapping the two devices together, it is contemplated that the transmission of the firmware and/or database update may continue or finish over the second wireless connection (e.g., Bluetooth). By the same token, the mobile communication device 120 may receive the diagnostic data of the vehicle 10 from the diagnostic tool 110 over the first wireless connection (e.g., NFC) and/or over the second wireless connection (e.g., Bluetooth). For example, the mobile communication device 120 may receive a first portion of the diagnostic data (e.g., including identification information of the vehicle 10 such as the VIN) over the first wireless connection and may receive a remaining portion of the diagnostic data over the second wireless connection after the NFC connection goes out of range. In this way, the system 100 may flexibly allow for bidirectional transmission of data between the diagnostic tool 110 and the mobile communication device 120 over one or both wireless connections as needed depending on the circumstances and the actions of the user. Advantageously, the first wireless connection (e.g., NFC) may primarily be used for smaller data transfers, such as to exchange pairing information and to transmit the VIN to look up a user profile as describe above, thus allowing the second wireless connection (e.g., Bluetooth) to be established in accordance with relevant connection rules and preferences associated with the user or vehicle 10. The larger data transfers, and especially the transfer of DTCs, live data, freeze frame data, and other diagnostic data from the diagnostic tool 110 to the mobile communication device 120 (but also firmware/database update data from the mobile communication device 120 to the diagnostic tool 110), may thereafter be completed primarily over the second wireless connection (e.g., in response to the first wireless connection being out of range).

The operational flow of FIG. 3 may conclude with the mobile communication device 120 producing a vehicle health report (VHR) based on the user profile and the received diagnostic data of the vehicle 10 (step 380). The VHR may include an identification of a defect in the vehicle 10, a recommended service item for the vehicle 10, and/or a recommended replacement part of the vehicle 10, for example. To produce the VHR, the mobile communication device 120 and/or one or more servers 130 in communication therewith may derive a diagnostic condition of the vehicle 10 from the diagnostic data package by comparing the retrieved diagnostic data with data (e.g., historical data) stored in one or more diagnostic databases. The diagnostic condition of the vehicle 10 may include, for example, information about the root cause of a problem that the vehicle 10 is exhibiting and/or an indication of one or more repair solutions or replacement parts for addressing the problem. Exemplary diagnostic methods, including the use of such diagnostic data to arrive at a most likely root cause and repair solution as well as vehicle-specific replacement parts, and in some cases the inclusion of a diagnostic router, are described in the following U.S. patent documents, each of which is owned by Innova Electronics Corporation of Irvine, California: U.S. Pat. No. 6,807,469, entitled AUTO DIAGNOSTIC METHOD AND DEVICE, U.S. Pat. No. 6,925,368, entitled AUTO DIAGNOSTIC METHOD AND DEVICE, U.S. Pat. No. 7,620,484, entitled AUTOMOTIVE MOBILE DIAGNOSTICS, U.S. Pat. No. 8,068,951, entitled VEHICLE DIAGNOSTIC SYSTEM, U.S. Pat. No. 8,019,503, entitled AUTOMOTIVE DIAGNOSTIC AND REMEDIAL PROCESS, U.S. Pat. No. 8,370,018, entitled AUTOMOTIVE DIAGNOSTIC PROCESS, U.S. Pat. No. 8,909,416, entitled HANDHELD SCAN TOOL WITH FIXED SOLUTION CAPABILITY, U.S. Pat. No. 9,014,908, entitled MULTI-STAGE DIAGNOSTIC SYSTEM AND METHOD, U.S. Pat. No. 9,142,066, entitled MULTI-STAGE DIAGNOSTIC SYSTEM AND METHOD, U.S. Pat. No. 9,026,400, entitled DIAGNOSTIC PROCESS FOR HOME ELECTRONIC DEVICES, U.S. Pat. No. 9,177,428, entitled PREDICTIVE DIAGNOSTIC METHOD, U.S. Pat. No. 9,646,432, entitled HAND HELD DATA RETRIEVAL DEVICE WITH FIXED SOLUTION CAPABILITY, U.S. Pat. No. 9,824,507, entitled MOBILE DEVICE BASED VEHICLE DIAGNOSTIC SYSTEM, U.S. Pat. No. 10,643,403, entitled PREDICTIVE DIAGNOSTIC METHOD AND SYSTEM, U.S. Pat. No. 11,068,560, entitled METHOD OF PROCESSING VEHICLE DIAGNOSTIC DATA, U.S. Pat. No. 11,270,529, entitled SYSTEM AND METHOD FOR PROACTIVE VEHICLE DIAGNOSIS AND OPERATIONAL ALERT, U.S. Pat. No. 11,158,141, entitled SYSTEM AND METHOD FOR PROACTIVE VEHICLE DIAGNOSIS AND OPERATIONAL ALERT, and U.S. Pat. No. 11,651,628, entitled ROUTER FOR VEHICLE DIAGNOSTIC SYSTEM, the entire contents of each of which is expressly incorporated by reference herein.

As described herein, various operational flows of the system 100 are contemplated, depending on the overall needs of the implementation (e.g., service center vs. individual use, level of functionality supported by diagnostic tool 110, etc.) as well as on the particular circumstances in which the system 100 is used (e.g., the size of files to be transferred, the actions of the user in tapping the diagnostic tool 110 with the mobile communication device 120, etc.) As such, the operational flow shown in FIG. 3 is only one example, and it is contemplated that one or more of steps 310-380 may be omitted or reordered. For example, in a case where the first wireless connection (e.g., NFC) is to be used for at least a part of the data transfer of step 360 and/or 370, these steps may be wholly or partly performed prior to establishing the second wireless connection (e.g., Bluetooth) in step 350. As another example, in a case where the second wireless connection (e.g., Bluetooth) is to be established irrespective of settings and preferences in a user profile, the VIN or other vehicle identification information may be transmitted at a later time together with the remaining diagnostic data, in which case steps 320 and 330 may be omitted.

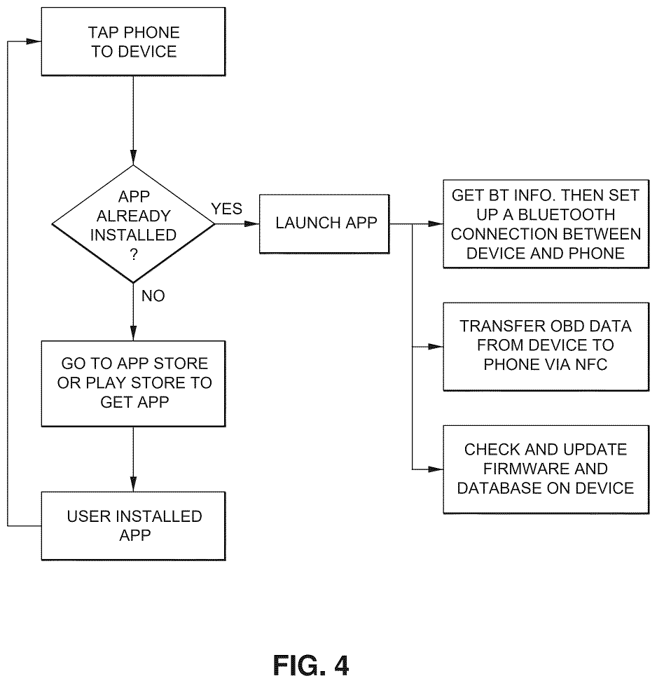

FIG. 4 shows another example operational flow of the system 100, illustrating one possible sequence of steps or use case. The operational flow may begin with the user tapping the mobile communication device 120 to the diagnostic tool 110. Depending on whether a supported mobile application (“app”) is installed on the mobile communication device 120, the NFC tap may either launch the app or take the user to the Apple App Store or Google Play Store to get the app (e.g., by encoding an appropriate URL in the NFC tag or controller), after which the user may install the app. In the latter case, the user may again tap the mobile communication device 120 (now with the app installed) to the diagnostic tool 110 to automatically launch the app. This may be done using native smartphone automatic shortcut functionality or a downloadable dedicated app (e.g., the iOS “Shortcuts” app) to trigger an action in response to a detected NFC ID. As explained above, the NFC tap may also transfer identification information (e.g., VIN) of the vehicle, which may be used by the app to look up a user profile and automatically change default settings in the app (e.g., choosing a preferred retailer for service/parts, preselecting certain diagnostic functionality, etc.). As shown, the operational flow may then continue with getting Bluetooth pairing information and setting up a Bluetooth connection between the diagnostic tool 110 and the mobile communication device 120, transferring diagnostic data from the diagnostic tool 110 to the mobile communication device 120, and checking for any firmware or database updates (and updating them) on the diagnostic tool 110. These processes may be performed over the NFC connection or the Bluetooth connection, or partly on one and partly on the other, as described above. It is contemplated that these processes may be performed autonomously (without further input from the user) upon launching the app or that one or more of the processes may be performed in response to a further NFC tap of the mobile communication device 120 to the diagnostic tool 110 or other confirmatory action on the part of the user. Example functionality that may be tied to one or more NFC taps (e.g., a sequence of taps) may include installing the app, launching the app, opening a specified page within the app (e.g., live data page), opening a user manual of the app or diagnostic tool 110, contacting product support, scanning the vehicle 10, scanning the engine, checking for engine codes, generating a report (e.g., engine codes, emissions readiness, suggested parts to fix the vehicle 10), sharing a report (e.g., via text, email, printout), sharing an invoice, making a payment, and/or installing/launching additional vehicle diagnostics apps. For functionality that does not require communication with the diagnostic tool 110 (or that makes use of diagnostic data already transferred to the mobile communication device 120 from the diagnostic tool 110, such as report generation), it is contemplated that an NFC sticker may be placed on the dashboard of the vehicle 10, near the OBD2 port, or at another convenient location instead of or in addition to the NFC tag or controller included in the diagnostic tool 110.

The functionality described above in relation to the diagnostic tool 110, mobile communication device 120, and server(s) 130 shown in FIGS. 1 and 2, as well as the operational flows described in relation to FIGS. 3 and 4 and throughout the disclosure, may be wholly or partly embodied in one or more computers including a processor (e.g. a CPU), a system memory (e.g. RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g., over the Internet), such as between the mobile communication device 120 and the server(s) 130. To the extent that any of the described functionality may be performed by the server(s) 130, the server(s) 130 may comprise multiple physical servers and other computers that communicate with each other to perform the described functionality.

The above computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A computer program product comprising one or more non-transitory program storage media on which are stored instructions executable by one or more processors or programmable circuits to perform operations for supporting vehicle diagnostics, the operations comprising:
establishing a first wireless connection with a diagnostic tool connected to a diagnostic port of a vehicle, the first wireless connection comprising a near-field communication (NFC) connection;
receiving identification information of the vehicle over the first wireless connection;
determining a user profile based on the identification information of the vehicle;
exchanging pairing information over the first wireless connection;
establishing a second wireless connection with the diagnostic tool based on the pairing information, the second wireless connection having a longer range than the first wireless connection;
receiving diagnostic data of the vehicle over the second wireless connection; and
producing a vehicle health report based on the user profile and the received diagnostic data.

2. The computer program product of claim 1, wherein the operations further comprise sending a firmware update to the diagnostic tool over the first wireless connection.

3. The computer program product of claim 1, wherein the operations further comprise sending a database update to the diagnostic tool over the first wireless connection.

4. The computer program product of claim 1, wherein said receiving diagnostic data of the vehicle over the second wireless connection is in response to the NFC connection being out of range.

5. The computer program product of claim 4, further comprising receiving diagnostic data of the vehicle over the first wireless connection, wherein the diagnostic data received over the second wireless connection is a remaining portion of diagnostic data retrieved from the vehicle by the diagnostic tool after the NFC connection goes out of range.

6. The computer program product of claim 1, wherein the identification information includes a vehicle identification number (VIN) of the vehicle.

7. The computer program product of claim 1, wherein the diagnostic data includes one or more diagnostic trouble codes (DTCs).

8. The computer program product of claim 1, wherein the diagnostic data includes live data.

9. The computer program product of claim 1, wherein the diagnostic data includes freeze frame data.

10. The computer program product of claim 1, wherein the vehicle health report includes an identification of a defect in the vehicle.

11. The computer program product of claim 1, wherein the vehicle health report includes an identification of a recommended service item for the vehicle.

12. The computer program product of claim 1, wherein the vehicle health report includes an identification of a recommended replacement part for the vehicle.

13. The computer program product of claim 1, wherein said determining the user profile includes communicating the identification information of the vehicle to one or more servers and receiving the user profile from the one or more servers.

14. The computer program product of claim 1, wherein said establishing the second wireless connection with the diagnostic tool is further based on the user profile.

15. A method of supporting vehicle diagnostics, the method comprising:
establishing a first wireless connection with a diagnostic tool connected to a diagnostic port of a vehicle, the first wireless connection comprising a near-field communication (NFC) connection;
receiving identification information of the vehicle over the first wireless connection;
determining a user profile based on the identification information of the vehicle;
exchanging pairing information over the first wireless connection;
establishing a second wireless connection with the diagnostic tool based on the pairing information, the second wireless connection having a longer range than the first wireless connection;
receiving diagnostic data of the vehicle over the second wireless connection; and
producing a vehicle health report based on the user profile and the received diagnostic data.

16. The method of claim 15, wherein said determining the user profile includes communicating the identification information of the vehicle to one or more servers and receiving the user profile from the one or more servers.

17. The method of claim 15, wherein said establishing the second wireless connection with the diagnostic tool is further based on the user profile.

18. A system for supporting vehicle diagnostics, the system comprising:
a diagnostic tool configured to connect to a diagnostic port of a vehicle to retrieve diagnostic data from the vehicle; and
a mobile communication device configured to establish a first wireless connection with the diagnostic tool, receive identification information of the vehicle over the first wireless connection, determine a user profile based on the identification information of the vehicle, exchange pairing information over the first wireless connection, establish a second wireless connection with the diagnostic tool based on the pairing information, receive diagnostic data of the vehicle over the second wireless connection, and produce a vehicle health report based on the user profile and the received diagnostic data, the first wireless connection comprising a near-field communication (NFC) connection and the second wireless connection having a longer range than the first wireless connection.

19. The system of claim 18, further comprising one or more servers in communication with the mobile communication device, the one or more servers being configured to receive the identification information of the vehicle from the mobile communication device and provide the user profile to the mobile communication device based on the identification information of the vehicle.

20. The system of claim 18, wherein the mobile communication device is configured to establish the second wireless connection with the diagnostic tool further based on the user profile.

21. The system of claim 18, further comprising one or more NFC stickers, wherein the vehicle health report is produced in response to an NFC tap of the one or more NFC stickers.
